(19) United States
(12) Patent Application Publication
(10) Pub. No.: US 2021/0090011 A1
(43) Pub. Date: Mar. 25, 2021

(54) Identifying and Tracking System for Searching Items

(71) Applicant: Andrew Marcus Fletcher Rae, Leduc County (CA)

(72) Inventor: Andrew Marcus Fletcher Rae, Leduc County (CA)

(21) Appl. No.: 16/582,016

(22) Filed: Sep. 25, 2019

(51) Int. Cl. G06Q 10/08; G06F 16/25; G06F 16/955; G06F 21/62; G06F 21/60

(52) U.S. Cl. CPC G06Q 10/087; G06F 16/252; G06Q 2220/18; G06F 21/6209; G06F 21/602; G06F 16/955

(57) ABSTRACT

Disclosed is a system for identifying and tracking items using unique product identifiers. In some embodiments, the system includes a central unit and an external unit. The central unit is coupled to the external unit. The external unit includes a plurality of products. The central unit is configured to generate a plurality of unique product identifiers (IDs). The central unit is further configured to authorize the external unit to access the plurality of unique IDs. Upon authorizing, the central unit accesses the plurality of unique IDs and assigns each of the plurality of unique IDs to a product of a plurality of products.

### REFERENCE TO PENDING APPLICATIONS

This application does not claim benefit of any issued U.S. patent or pending applications.

### BACKGROUND OF THE INVENTION

### Field of the Invention

The present invention relates generally to an identifying system, and in particular to a system for identifying and tracking items using unique product identifiers.

### Background

U.S. Pat. No. 8,705,873B2 discloses a method and apparatus for protection of various items against counterfeiting using physical unclonable features of item microstructure images. The protection is based on the proposed identification and authentication protocols coupled with portable devices. In both cases a special transform is applied to data that provides a unique representation in the secure key-dependent domain of reduced dimensionality that also simultaneously resolves performance-security-complexity and memory storage requirement trade-offs. The enrolled database needed for the identification can be stored in the public domain without any risk to be used by the counterfeiters. Additionally, it can be easily transportable to various portable devices due to its small size. Notably, the proposed transformations are chosen in such a way to guarantee the best possible performance in terms of identification accuracy with respect to the identification in the raw data domain. The authentication protocol is based on the proposed transform jointly with the distributed source coding. Finally, the extensions of the described techniques to the protection of artworks and secure key exchange and extraction are disclosed in the invention. The storage of the item surface images (fingerprints), their compressed versions or features in open or even encrypted form (with the need of prior decryption before identification/authentication) is not secure. The disclosure of the database might lead to the attempts of reverse engineering and creation of faked fingerprints (these attempts in biometrical fingerprint applications are well known [33]. At the same time, possessing the discriminative features extracted from the surface microstructure images, the attacker can deduce the information about the decision regions of identification/authentication procedures using a so-called sensitivity attack. The present invention avoids these possibilities using non-invertible one-way cryptographic like mapping of the original item surface image into binary or real numbers that represent the relative relationships between the vectors in the secure key-defined domain.

WO2017114791A1 discloses methods, network devices, and machine-readable media for an integrated environment for generating a secure item identification code associated with or based on a measured physical property of an item, such as a label or a stamp. In some embodiments, the label identification code can be generated as a digital signature using a signature module. The signature module can receive the physical property data, an authorization key, a security token or any combination of them. In some embodiments, the signature module may receive, in addition, one or more intrinsic machine, product, or product item characteristics, or any combination of those characteristics alone or in combination. The signature module can create a digital signature based on any or all of those inputs.

US20180034640A1 discloses a method and system for authenticating a production of products. The method and system comprise determining if configuration data for the production run is authorized and, if the production run is authorized, generating a security token and associating the token with configuration data. The configuration data is digitally signed by generating a digital signature and associating the digital signature with the configuration data. The digital signature associated with the digitally signed configuration data is verified. Products are then produced in a production run according to the digitally signed configuration data, and the set of secure product identifiers is printed on the products according to the digitally signed configuration data. The Authorization Module can be embodied as a hardware security module (HSM), or another type of physical computing device that safeguards and manages digital keys for strong authentication and providing crypto processing. The Authorization Module functionality can be performed by a computer with an embedded board with an encryption key or PKI private key. The module can be equipped with features such that attempts to access the data will result in it being rendered unreadable or inaccessible. If the input to the Authorization Module is a range and an algorithm, the Authorization Module can output an identity in the range of authorization and a security token of the identifier. For example, the output identity can be a range from 0 to 1,000 with a security token for each item in the range.

WO2016192537A1 discloses a system for establishing a product authenticity identification data module by using the Internet of Things comprises: at least one product, wherein a product identifier is configured on each product; a reading device, having a specific user identifier and a coordinates positioning device, so as to read a product identifier of a product; a cloud device, having a function of communicating with the reading device; and an agent servo device, having a URL and a password, and being capable of communicating with the reading device and the cloud device, so as to directly transmit, to the cloud device, the production identifier read by the reading device as well as reading time and a reading position. In the cloud device, the product authenticity identification data module that has a relationship in which the reading time is corresponding to the reading position is established according to the production identifier.

CN203966190U discloses a utility model for product traceability anti-fake cloud system based on an internet of things system. The product traceability anti-fake cloud system based on the internet of things system comprises an internet of things product traceability anti-fake cloud system, a data center, an anti-fake label and a hand-held device, wherein the internet of things product traceability anti-fake cloud system is connected with a client of an enterprise via a cloud platform and records the information of the enterprise, the data center is arranged inside the enterprise, is an enterprise data management terminal, is connected with the internet of things product traceability anti-fake cloud system, records and stores the accepted product information of the enterprise, and records the product information on the anti-fake.

US20180205543A1 discloses a method of defining a numerical basis by combining at least two different ranges of numbers which can be used to obfuscate an alphanumeric character. This basis can be used for product identification or other methods of creating unique tracking or identification numbers when used in combination with conversion functions.

U.S. Pat. No. 7,874,494B2 discloses an object comprising first coded data disposed on or in a surface thereof and an identifier. The first coded data identifies a plurality of locations on the surface and the identifier identifies a unique identity of the object. The first coded data and the identifier are distinguishable from each other and are independently readable. In an online environment the signature can be validated, in conjunction with the region ID, by querying a server with access to the secure database. If the “region has embedded data” and “embedded data is signature” flags in the region flags are set, then the surface coding contains a 160-bit cryptographic signature of the region ID. The signature is encoded in a one-block superblock. Each object ID has a signature. Limited space within the Hyper label tag structure makes it impractical to include a full cryptographic signature in a tag so signature fragments are distributed across multiple tags. A smaller random signature, or secret, can be included in a tag.

U.S. Pat. No. 9,646,310B2 discloses method includes printing a readable and writeable memory on an object, using a seed to generate an original value, writing the original value to the memory, and sending the object to a recipient. The method may also include receiving the object at the recipient, determining the seed from a characteristic of the object, generating an authentication value using the seed value, and comparing the authentication value and the original value.

U.S. Pat. No. 7,387,249B2 discloses a The present invention provides for a system and method for product verification for use with products intended to be introduced into circulation and including machine readable product data, and comprising a product data storage means, at least one portable reading device for said machine readable product data, wherein the machine readable product data is applied to products and is arranged for inspection by the at least one portable reading device remotely from the product data storage means and at least one point in the product circulation route, and wherein the at least one portable reading device is arranged to verify the authenticity of the machine readable product data and thereby verify the authenticity of the product itself. In a further embodiment the interface to the computerized product data storage system incorporates security means. In one instance the security means comprises encryption algorithms.

WO2000030043A1 discloses methods for identification of inspected objects and can find application in identification of goods liable to an excise duty (alcohol, tobacco, video products), documents providing free or privileged travel by public transport, authenticity of personal identity documents, etc. The objective of the present invention is to provide a method allowing 100% trustworthy determination of authenticity of an inspected object and identification of the marker. The above objective is attained by a method for identification of authenticity of an inspected object comprising application of marks which contain object-related information to this object with subsequent readout of this information and comparison of the information thus read out with the database of authentic objects, wherein the object-related information is formed in a digital form including information about the object type, manufacturer, manufacturing date, unique number of the object, object-accompanying documents, and signed with an electronic digital signature of the marker, the resulting information is converted to a bar code which is applied to the object or a label fastened to the object, and during readout of the information the bar co-de is converted to a digital form, and the electronic digital signature and the object-related information are selected therefrom, after which the electronic digital signature is verified for authenticity, and, if the signature is authentic, verification of the object for authenticity is carried out by comparison of the read information with the database of authentic objects, and, if this information is coincident, the object is identified as an authentic one, but, if the electronic digital signature is identified inauthentic or if the electronic digital signature is identified as authentic and the object-related information as inauthentic, then the object is identified as an inauthentic one.

### BRIEF SUMMARY OF THE INVENTION

In some embodiments, system for identifying and tracking items using unique product identifiers. In some embodiments, the system includes a central unit and an external unit. The central unit is coupled to the external unit. The external unit includes a plurality of products. The central unit is configured to generate a plurality of unique product identifiers (IDs). The central unit is further configured to authorize the external unit to access the plurality of unique IDs. Upon authorizing, the external unit accesses the plurality of unique IDs and assigns each of the plurality of unique IDs to a product of a plurality of products.

In some embodiments, the central unit generates a crypto token for each of the products. The central unit further generates a webpage for each of the products with a unique ID. The webpage includes at least one of: metadata about the product, or metadata about a manufacturer of the product and will be used to identify the products. The information in the webpage may further be used by a user to compare products. In some embodiments, each of the plurality of unique IDs includes at least one of: a type of the product, a model number of the product, a product image, a brand name of the product, or a logo of a brand of the product.

In some embodiments, the central unit generates a license-to-use document. The central unit then sends the license to use to the external unit. In some embodiments, the central unit assigns a life expectancy to each product that is assigned a unique id. The central unit then removes a token and metadata about the product. the life expectancy can be determined based on one or more criteria such as, but not limited to: an expiration date of the product, a pre-determined time, a pre-determined time after a specified event, or a sale of a product. In some embodiments, the central unit determines that a product that is not assigned a unique id is up for sale. In such embodiments, the central unit sends a notification to the external unit. The notification includes an alert regarding the sale of an unauthorized product. In some embodiments, the central unit is able to directly cancel the sale of an unauthorized product.

In some embodiments, the system includes a central unit which is configured to connect to one or more additional external units. The central unit further determines one or lost products from the one or more additional external units. The central unit is configured to create a database of the lost products. The database of lost products includes a plurality of ID-assigned lost products of the plurality of additional external units. In some embodiments, the database of lost products is a searchable database. The lost products can be searched based on one or more criteria such as, but not limited to: a product name, a product color, a product brand, or a product unique product identifier.

### BRIEF DESCRIPTION OF THE DRAWINGS

FIG. 1 illustrates a system for identifying and tracking items using unique product identifiers, in accordance with some embodiments.

FIG. 2 illustrates a system for identifying and tracking items using unique product identifiers, in accordance with some embodiments.

In accordance with common practice some features illustrated in the drawings cannot be drawn to scale. Accordingly, the dimensions of some features can be arbitrarily expanded or reduced for clarity. In addition, some of the drawings cannot depict all of the components of a given system, method or device. Finally, like reference numerals can be used to denote like features throughout the specification and figures.

### DETAILED DESCRIPTION

It will also be understood that, although the terms first, second, etc. are, in some instances, used herein to describe various elements, these elements should not be limited by these terms. These terms are only used to distinguish one element from another. For example, a first device could be termed a second device, and, similarly, a second device could be termed a first device, without departing from the scope of the various described embodiments. The first device and the second device are both devicees, but they are not the same device, unless the context clearly indicates otherwise.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It should be appreciated that in the development of any actual embodiment (as in any development project), numerous decisions must be made to achieve the developers' specific goals (e.g., compliance with system and business-related constraints), and that these goals will vary from one embodiment to another. It will also be appreciated that such development efforts might be complex and time consuming but would nevertheless be a routine undertaking for those of ordinary skill in the art of image capture having the benefit of this disclosure.

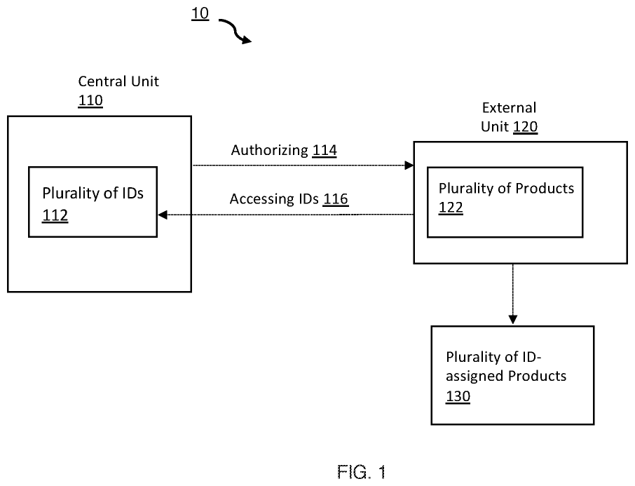

FIG. 1 illustrates a system for identifying and tracking items using unique product identifiers (IDs), in accordance with some embodiments. In some embodiments, the system 10 includes a central unit 110 and an external unit 120. The central unit 110 is coupled to the external unit 120. The external unit 120 includes a plurality of products 122. The central unit 110 is configured to generate a plurality of unique product identifiers (IDs) 112. The central unit 110 is further configured to authorize 114 the external unit 120 to access the plurality of unique IDs 112. Upon authorizing, the external unit 120 accesses 116 the plurality of unique IDs 112 and assigns each of the plurality of unique IDs 112 to a product of a plurality of products 122.

In some embodiments, the central unit 110 generates a crypto token for each of the products with an assigned unique ID 112. The central unit 110 further generates a webpage for each of the products with an assigned unique ID 112. The webpage includes at least one of: metadata about the product, or metadata about a manufacturer of the product and will be used to identify the products. The information in the webpage may further be used by a user to compare products.

In some embodiments, each of the plurality of unique IDs 112 includes at least one of: a type of the product, a model number of the product, a product image, a brand name of the product, or a logo of a brand of the product.

In some embodiments, the central unit 110 generates a license-to-use document. The central unit 110 then sends the license to use to the external unit 120.

In some embodiments, the central unit 110 assigns a life expectancy to each product that is assigned a unique ID. The central unit 110 then removes a token and metadata about the product. The life expectancy can be determined based on one or more criteria such as, but not limited to: an expiration date of the product, a pre-determined time, a pre-determined time after a specified event, or a sale of a product.

In some embodiments, the central unit 110 determines that a product that is not assigned a unique ID is up for sale. In such embodiments, the central unit 110 sends a notification to the external unit 120. The notification includes an alert regarding the sale of an unauthorized product. In some embodiments, the central unit 110 is able to directly cancel the sale of an unauthorized product.

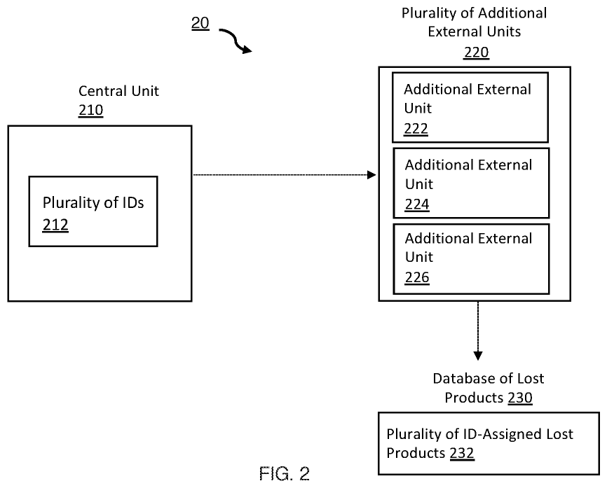

FIG. 2 illustrates a system for identifying and tracking items using unique IDs, in accordance with some embodiments. In some embodiments, the system 20 includes a central unit 210 which is configured to connect to one or more additional external units 220, e.g., additional external unit 222, additional external unit 224, additional external unit 226. The central unit 210 further determines one or lost products from the one or more additional external units 220. The central unit 210 is configured to create a database of the lost products 230. The database of lost products 230 includes a plurality of ID-assigned lost products 232 of the plurality of additional external units 220.

In some embodiments, the database of lost products 230 is a searchable database. The lost products can be searched based on one or more criteria such as, but not limited to: a product name, a product color, a product brand, or a product unique product identifier.

In some embodiments, the identifying and tracking system provides an ability to search for items, connect with owner, and complete peer to peer or via API to Peer transactions of ownership. For example, the system provides a set of device to device, or a device to email transactions of a product, using its unique identifier issued by central unit and/or an existing manufacture identity product label using manufacture name, brand name, model number, serial number, etc. to identify the products individuality.

In some embodiments, multiple types of unique identifiers operate independently or in conjunction a multiple identifier; together against a single crypto token. The system backend interacts with the Crypto's ledger record to determine the correct allocation of data stored on a cloud server or other formats of storage.

As an example, company A is a holder of a brand/trademark. Company B wishes to manufacture products that use the trademark of brands/logos of company A. Company A can create a product model that defines the type of product, model number, product image, brand names and logos used and files that are attached to each of the items. Company A then sets parameters for a licensed production run that determines limitations for company B. At the completion, a permission is provided to company B's account on the system 10, and the company B finds that it is able to access the product model from within its account. Now company B can select each item and scan unassigned IDs to align the product data as a licensed product of Company A. In some embodiments, company B scans a product's unique ID to align the product model data. Alternatively, company B may request unique IDs that include product model data pre-assigned (i.e., the product manufacture is differentiating each product until the manufacturer implements unique IDs to each product). For example, the central unit supplies a bulk delivery of several serial numbers (i.e., pre-assigned data) and the manufacture subsequently does at least one of: a tamping method, a printing method, an embedding method, etc. or any other suitable method onto its products.

In some embodiments, the system generates crypto tokens and webpages of an equal quantity of the products defined by Company A. The system allows Company B to assign product data to product or packaging identifiers that use company A's. The system limits company B in how many licensed products it can produce. System does not assign data against identifiers after the allotted quantity is reached. In some embodiments, synchronization scans and/or reads of IDs beyond the set quantity stops and the system will not synchronize additional product to the data as there is no tokens to link to.

In some embodiments, a life expectancy of an item is defined by the manufacture in years/months/days. Once the date has been exceeded by a set amount, the system will automatically delete the item's token/file from the system.

In some embodiments, the system is used to reschedule an event/concert. In some embodiments, the system is used for on-screen notification of potential fraudulent when incoming call number matches a number from list of potential fraudulent calls. In some embodiments, the system provides POS software to access the block-chain ledger to verify a transaction. The system may not allow the transaction of certain products, including the ordering or addition of items into or out of, account holders ledger/inventory.

The system may use identifiers/crypto token to verify authenticity of a product based on the displayed result from a webpage or from within an owner's inventory item page, and the history provided. The system may prevent a sale of a product in certain jurisdictions, by certain account types, where an existing trademark item has an existing legal right of use, e.g., a manufacture name, brand(s) verified trademark registration with governing body(s), type of product that the brand is applicable to, and jurisdictions that the trademarked product is protected in. In some embodiments, an authenticity user can determine the validity of product identifier by a response page using a specified domain or its sub domain. In some embodiments, all of the unique identifiers have a trademark icon related to them, i.e., a QR code. Alternatively, in some embodiments, some of the unique identifiers have a trademark icon related to them.

In some embodiments, IDs and crypto tokens and data are generated with specific item pre-aligned to the specific item. I some embodiments, no specific item data is assigned to the identifier address and value or crypto token. For example, RFID, NFC, Bluetooth, WIFI, or any other method of tagging may be used to attach or embedded to an item or its packaging. The ID may contain a web domain URL, a unique id address and id value and access password. Identifiers can be used on or embedded in the item or on the packaging or packaging label. The items are tagged with a specific tag and can be detected by any existing method of tagging, such as NFC, RFID, Bluetooth, etc. the system may provide the users a downloadable software to communicate with the system online and through the user devices.

In some embodiments, a customer can add items to personal inventory. The customer can add image(s) of the item. An image matching recognition software generates the product term and a search reference. The customer can add items manufacture label and the system extracts values such as model, serial number, manufacturer, company name, etc. The customer can further enter a proof of purchase document and a time/date/location of the entering the data into the system. The item details and its values are searched against all available databases; internal system for existing in database, and external database(s) for items lost or stolen reports, and to access law enforcement by use of an API. A crypto token is then generated on a block-chain or graph ledger for the item. Item is then stored in database against the user's crypto token, and user's device is updated with the item/crypto token in the inventory.

Alternatively, a manufacture can use IDs that are supplied by the system or produce their own from a graphic or data file provided from the system. A manufacturer creates a manufacture account and inputs the company details. The manufacturer creates a product model for the items that it produces, inputs item details and attaches data files for this product. The manufacture selects which type of identifier(s) will be used on the product they produce. Unique identifiers examples are a QR code, a unique alphanumeric serial number, a pre-encoded NFC microchip or an NFC microchip that will be encoded with an address, value and password, and packaging label (typically used on exterior box to connect the item inside with the crypto token/database files and values, allowing a tracking or transfer of the item, to occur without opening). In general, any type of identifier can be used on packaging, e.g., QR Code, NFC, unique serial number, Bluetooth device, etc. Packaging identifier or design may cause the software/hardware to active a read for the identifier on/in the product within the packaging. The package label may be a standalone link between the product, e.g., (no identifier, the crypto-token on a ledger/block-chain, e.g., centralized or decentralized ledger, with the products data and all files on the cloud server.

In some embodiments, once an authorized user signs-in to a manufacture account, his device is set to a synchronization mode and the user selects the correct product from a list of product model or production run where control values are implemented (such as the total quantity or mandatory fields controlled). The user can further select the current process, e.g., acquiring the packaging identifier. User device's camera or reading hardware or externally connected hardware can open or activate the system. The product identifier(s) are presented to the reading/acquiring hardware and the identifier's web URL address, unique encoded value id number and password are acquired. The software then allocates this data against a crypto-token and the ledger is updated. For example, a manufacturer may select/enter a label/field and its respective value to assign new data. This way, when the manufacturer selects and individual production run or scans each packaging label, the system automatically updates the webpage of that product with the new assigned data.

The software then aligns the crypto token against the product model data in the backend servers. The manufacture's account then receives the item into its inventory. An image recognition engine that is configured to recognize shapes, images and text, including a combination of designs and/or icons with text and/or numerals causes a hardware device to activate/read data. The image recognition engine may further cause to acquire/advance the device to a webpage or a mobile application display corresponding to the product. Typically, the hardware is an NFC microchip, but the system supports use of any suitable identifier.

Usually companies/stores/facilities have an area or a small drawer/box where found items are placed with the hope that the owner will realize and remember the place, they have misplaced an item. In some embodiments, a connected lost and found database is created and is used in a network for these places that is searchable allowing users to either search for, claim items and add items to the lost and found. There are two types of lost and found databases: 1) an unsecured box or storage area that is open to any person, and 2) a lost and found holding, that requires an authorized person to access, typically by a store employee. For latter type of lost and found, by using the software, any person claiming a item must provide a description or explain some feature that proves that this is their property, the administrator can view the entry and allow or disallow the claim, remove or return the item. This system is supported by individual websites for each lost and found and/or downloadable application. An account can have multiple lost and founds in different locations against the one single account. To search for an item in the connected lost and found, the user can enter the item details of which he/she is searching for, such as: common item name, color of item, brand name, etc. Software then finds best or possible matches and provides a result to the searcher. Search can be limited or adjustable by a search distance control, measuring to user's location to a proximity of physical lost and found locations, user's recent travel path by using a history of the users device to create a search filter of all connected lost and found databases along the route of travel to search for an item matching at the accounts of the physical locations near to the recorded path of travel. The user can limit or set the number of days or hours that the recent travel path history that uses in search filter system. The distance extending in each direction form the recorded travel path can be adjusted. As a non-limiting example, the system may search all connected lost and found databases within 200 or 500 meters of every place the user has been in or traveled through, for the last 3 or 5 days.

To add an item to the database, the uses camera captures item the item and record the location of the location from metadata. The item recognition software creates search term that matches the item and suggests entry of product type. The system then tracks the duration that the item is in the lost and found database. When this process is completed, the system creates a searchable result and item is available to claim. When the user who is adding the item by using the website, the system accesses user's device to check his location which is measured against the recorded location of the lost and found database. The user must be within a defined proximity of the recorded lost and found location to activate functions of the system, e.g., to add an item to the lost and found.

The system allows a user to claim an item that is recorded in a physical lost and found from a distance using the app or the web service. For items that are in a secured lost and found location, the claimer must enter a description of detail, proving that the item belongs to him/her. From scanning the decal at a physical lost and found location, a list is displayed to the user, where the user can select items images to claim/remove item from lost found. For claiming an item at a physical lost and found, system measures the user's location and that of the physical lost and found decal to determine that the action is authentic and prevents claim if the user is not within the system defined proximity value. Individuals can access the network system by preforming a QR read or NFC chip read to access the website, after security protocols completed, or inside the personal account of the user downloaded application. In some embodiments, the system determines a location of an item's claimant relative to an area around the lost and found location, prior to the item being added to the system. Then the system provides a display to assist administrators in the determination of the claimant's legitimacy of ownership claim of the item. For example, when a sunglasses is claimed by X, and X was near to or at coffee house Y, certain time prior to when the sunglasses was added to coffee house Y's lost and found.

A business or facility can create an account by scanning a sticker/decal or threw the downloadable software to receive a print version decal with the account detail allocated against this lost and found account and specific location after entering the software from a sticker/decal that does not have an account assigned to QR Code's web address, and ID value. A camera is used to record the area of the lost and found, the location is recorded, and a browser is used.

In some embodiments, a tool from within the application allows a user to user the camera device to recognize an object, its identification label and search multiple databases for reports of theft or loss against the item. A user can also manually input a products details into the system to perform a search. The system database is additionally searched for a record of who the owner is and responds with the owner details and search result to the user's device.

In some embodiments, notification delivery directly takes place to registered owner and a person or group of people, such as family members or an associate, or to an email account if no account or device acquirement route is associated with ownership file for items Token. The system can be used as a broad-spectrum broadcast or narrowed by the input values to filter to only deliver to the product owner or users in product owner group or family account, or to a person/people within a definable area. At time of acceptance or dismissal, by the user, the device records this action and message on screen and measures the user's biometric data to determine receiver's identity, and then records to a file, on the server, a cloud server, a flash, a magnetic drive or any suitable storage system. In some embodiments, if there is not an identity match between an intended recipient of the notification who accepts or declines the notification, then the message is considered undelivered and the notification is reissued.

Notification may provide links to additional information or arrange repair or other services, or the user can provide a video evidence of disposal of the item. The user may provide compensation to registered owner. Notification receivers may be based or history of purchases.

In some embodiments, the system may capture videos. While capturing a video, if a products unique identifier is captured/read, the video file can irrevocably log against this item or its crypto token. A crypto token is generated for the video file and recorded in a ledger. The video can be edited to post attachment. Capturing the identifier may be retained to be displayed in edited version. The record of the item's identifier read, and the pursuant file is locked, and cannot have changes other than shortening of the version display for the user when replayed. The system allows a user to attach a video/image file against an item, or its crypto token). This can be facilitated from an item identifier scan result/items webpage, or from within the user account by selecting the item from his/her inventory and using a feature/function on a control panel for the specific item.

The images may be altered to match or camouflage their existence on the display media in various levels of difficulty to discern. Icon/rewards may be moving in a manner that is unpredictable or speed causing the capturing to be at different levels of difficulty. Capturing token may be complete by tapping or selecting and dragging to a specific area. The levels of difficulty are an adjustable feature and are controlled by the reward issuer, e.g., the manufacture or retailer account holder who is in possession of the items crypto token, and therefore the item. Each reward is tied to a crypto token. In some embodiments, this may be limited to preventing the claiming of rewards/prizes until a retail sale has occurred, or placing items ownership into a consumers account.

When a transaction that creates a change to the crypto ledger occurs, the items webpage automatically updates to display the current owner's profile of item, adjust the history, and contact owner information. If the item has moved from a retail account to a consumer account, features available at the web page are adjusted and tracking functions such as warranty clock countdown begin. If an item is defined as belonging in a specific account type, then the item's web page reflects a defined layout. For example, when an item is not registered to a retail providing account functions such as “purchase now” are not available to the user. Previous owners and the supply chain can be viewed by swiping the ownership profile display boxes, to expose the previous history below until the first manufacture account holder is displayed. The system allows to contact the user to send a message to the owner requesting communication about the item, thereby sharing contact details to the owner without revealing the owners contact information. The owner can reply or block the communication requester. The system provides access to video attachments that are attached by the users. The system further provides access to attached product data or video file, which is dynamically added by the manufacture account and assigned in the product model. A warranty clock provides a real-time data as to when the warranty service will expire or if it already has. It also provides an ability to make a claim to the warrantee provider, communicate with warrantee support provider, supply video file evidence, receive instructions, or receive compensation. In some embodiments, viewing previous owners and supply chain may be accomplished by other methods than swiping. For example, a separate webpage may be designed to show previous owners and supply chain.

In some embodiments, a downloadable, installable software provides the ability for point of sales (POS) software systems to read product identifiers receive. In some embodiments, POS may request changes in the ownership ledger for transactions of merchandise, e.g., a sale or a return of the merchandise. Alternatively, POS may access the identity verification system to determine purchaser's identity and his/her payment method authorization, e.g., not a fraudulent use of a credit card. In some embodiments, POS may determine the item's new owner by way of the customer identity verification, or method of payment used, e.g., a certain credit card belong to A was used to provide payment, therefore ownership transfers to A with corresponding credit card number. In any events, the system prevents, i.e., does not allow, an individual person to have a plurality of identities.

In some embodiments, a database may maintain a partial or full profile information of a user for matching identity values and irrevocably tying the account profile to a unique user profile token. A user identity for the unique profile may be determined by directly input or through other known methods of inputting identify data, including scanning or wireless read from various identification sources, such as a driver's license, passport or other government identification source.

In these embodiments, the unique user identity data can be compared against other known identify, or measurement, values for the user, such as facial recognition features, or any other identity verifier that may be stored within the system for the initial identity determination. The additional identification measurement or a response values may be, but not limited to: fingerprints, form voice recognition, eye/iris, from NFC tag or wireless reading/communications to Rfid device, Bluetooth, wifi. For example, if the system recognizes a user from facial measurements and the system also has a measurement record of the user's voice, the system may access a hardware device, such as a microphone, and measure/match the vocal characteristics of the user. This allows for the user's secondary registered identification verifiers to be confirmed even if the user entered his name was differently entered. In these embodiments, when an identity is matched, the system may issue a verification request to the device on the database corresponding with the user's profile.

These embodiments allow for a determination of whether or not the person or thing is a matched to the correct existing account and to allow for the addition of new profile identity measurements which were not previously in system. A profile's history information may be returned from database, providing history reports on: credit applications, fraudulent activity, employment, income levels, citizenship.

In some of these embodiments, each unique identity is issued a crypto token. Embedded within this token are the unique user profile identity measurement values and identity information.

This allows for a more secure verification system. For example, if a user's email account security is breached by a hacker, the hacker may make a “forgot password” request. Most systems will then send a reset password code to the compromised email address, thereby allowing for a complete loss of the application's account. These embodiments send an identity verification portal link to the email or use in application provided measuring systems. These embodiments require a match to one or more of the measurement values associated with the unique user profile.

In another example, it is a known that organized crime uses “straw buyers” to purchase automobiles, and such practice is harmful for banks and law enforcement. These embodiments provide a portal service to financial institutions in order to prevent this type of fraud. In these embodiments, as part of a credit application when purchasing a vehicle, a user will need to be validated against the unique user profile identity measurement values and identity information before the financing could be secured.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method of identifying and tracking one or more products in a system, wherein the system comprises a central unit coupled to an external unit, wherein the external unit comprises a plurality of products, the method comprising:
generating, by the central unit, a plurality of unique product identifiers (IDs);
authorizing, by the central unit, the external unit to access the plurality of unique IDs;
accessing, by the external unit, the plurality of unique IDs;
assigning, by the external unit, each of the plurality of unique IDs to one product of the plurality of products, and
identifying, by the central unit and the external unit, the products with an assigned unique ID as authentic products.

2. The method of claim 1, further comprising:
generating, by the central unit, a crypto token for each of the products with an assigned unique ID, and
generating, by the central unit, a webpage for each of the products with an assigned unique ID.

3. The method of claim 2, wherein the webpage includes at least one of: metadata about the product, or metadata about a manufacturer of the product.

4. The method of claim 1, wherein each of the plurality of unique IDs includes at least one of: a type of the product, a model number of the product, a product image, a brand name of the product, or a logo of a brand of the product.

5. The method of claim 1, further comprising:
generating, by the central unit, a license to use document, and
sending, by the central unit, the license to the external unit.

6. The method of claim 1, further comprising:
assigning, by the central unit, a life expectancy to each product that is assigned a unique ID, and
removing, by the central unit, a token and metadata about the product,
wherein the life expectancy is determined based on one or more criteria.

7. The method of claim 6, wherein the one or more criteria includes at least one of: an expiration date of the product, a pre-determined time, a pre-determined time after a specified event, or a sale of a product.

8. The method of claim 1, further comprising:
upon determining a sale of a product that is not assigned a unique ID, sending, by the central unit, a notification to the external unit, wherein the notification includes an alert regarding the sale of an unauthorized product.

9. The method of claim 1, further comprising:
connecting the central unit to one or more additional external units;
determining, by the central unit, one or more lost products from the one or more additional external units, and
generating, by the central unit, a database of lost products.

10. The method of claim 9, wherein the database is a searchable database, wherein the lost products can be searched based on one or more criteria.

11. The method of claim 10, wherein the one or more criteria includes at least one of: a product name, a product color, a product brand, or a product unique product identifier.
